(19) United States
(12) Patent Application Publication
(10) Pub. No.: US 2005/0093387 A1
(43) Pub. Date: May 5, 2005

(54) Electrical insulation arrangements for electric fans, motor assemblies and controls therefor

(76) Inventors: Yung Chen, Claredon Hills, IL (US); Benjamin Bain, Plainfield, IL (US); Manuel Almanza, Chicago, IL (US)

Correspondence Address: WILLIAM J. LENZ, 311 S. WACKER DRIVE, 53RD FLOOR, CHICAGO, IL, 60606-6622, US

(21) Appl. No.: 10/696,647

(22) Filed: Oct. 29, 2003

(51) Int. Cl. H02K 5/00; F04B 35/04

(52) U.S. Cl. 310/91; 310/89; 417/423.14

(57) ABSTRACT

The present invention generally provides electrical insulation arrangements for electric fans, motor assemblies and controls therefor. According to a particular aspect of the invention, an electric motor for an electric fan having a fan housing is provided. The motor comprises a motor casing having an insulator mounting arrangement configured for mounting the motor to the fan housing. The mounting arrangement comprises a mounting portion of the motor casing, and an insulating member mounted to the mounting portion of the motor casing without a separate fastener. The insulating member is configured to accept a fastener that can be utilized to mount the motor casing to the fan housing such that the fan housing would be insulated from the motor casing. Other aspects are also provided.

### TECHNICAL FIELD

The invention relates to electric fans, and more particularly to electric fans having electric motor assemblies and related components mounted therein.

### BACKGROUND OF THE INVENTION

Electric fans of all types have traditionally been an effective way to provide climate control within a living space. During the summer months, electric fans provide a very low cost solution to keep air circulating within a living space, and hence, help keep temperatures from reaching uncomfortable, and sometimes dangerous, levels. In recent years, electric fans have been made increasingly efficient and more powerful through advancements in electric motor technology. Many electric fans today, such as box fans, incorporate four pole and six pole split capacitor motor technology. While this technology increases efficiency and power, it does require relatively higher operating voltages.

While existing electric fan assemblies have all been designed to be safe for their intended use, it is desirable to not only meet, but exceed safety standards set by various organizations, including independent organizations such as Underwriters Laboratories (UL). With this goal in mind, it is desirable to electrically isolate electric motors from other portions of the fan assembly. This is especially true when the fan is being operated in very humid conditions or when the air being moved by the fan has high moisture content. Condensation caused by the air can create a current leakage pathway between the fan motor and other parts of the fan, such as a metallic shroud of a typical box-type fan. In such cases, these other parts of the fan can become electrically charged. Electrical isolation of the fan motor prevents such occurrences.

Presently-known attempts at electrical isolation have many drawbacks. For example, U.S. Pat. No. 6,309,192 discloses an insulated box fan that employs aplastic isolator ring that is attached to the fan housing at a first set of points and separately attached to the fan motor at a second set of points. The attachments are implemented with screws. One problem associated with this fan is the difficulty in alignment of the attachment points between the isolator ring and the motor. This difficulty is created by the ring being a single component having multiple attachment points. Because all of the attachment points are fixed to a single component, alignment of the attachment points are linked together, thereby creating alignment and tolerance constraints. This creates manufacturing quality concerns. Furthermore, because the isolator ring is a single component, it is more susceptible to manufacturing defects caused by inconsistencies between each of the attachment points, dimensional or otherwise. Another problem is the cost of the components and the assembly. Because of the multiple attachment points, the number of screws needed for the attachment points, the size of the isolator ring, and other factors, the assembly is relatively costly.

It has also been found that a combination of insulating solutions can be more effective than merely incorporating an insulator between the motor and the fan housing as shown in the '192 patent. Among its other shortcomings, the '192 patent does not disclose any such additional insulating solutions.

### SUMMARY OF THE INVENTION

The present invention generally provides electrical insulation arrangements for electric fans, motor assemblies and controls therefor.

According to a particular aspect of the present invention, an electric motor for an electric fan having a fan housing is provided. The motor comprises a motor casing having an insulator mounting arrangement configured for mounting the motor to the fan housing. The mounting arrangement comprises a mounting portion of the motor casing, and an insulating member mounted to the mounting portion of the motor casing without a separate fastener. The insulating member is configured to accept a fastener that can be utilized to mount the motor casing to the fan housing such that the motor casing and the fan housing are insulated from each other.

According to another aspect, an insulated mounting arrangement for mounting an electric motor to a fan housing of an electric fan is provided. The arrangement comprises a mounting portion of the motor casing, an insulating member mounted to the mounting portion of the motor casing without a separate fastener, and a fastener disposed through a portion of the fan housing and within the insulating member such that the fastener is insulated from the motor casing.

According to another aspect, an electric motor for an electric fan having a fan housing is provided. The motor comprises a motor casing having an insulator mounting arrangement configured for mounting the motor to the fan housing. The mounting arrangement comprises a mounting portion of the motor casing, and an insulating member mounted to the mounting portion of the motor casing without a separate fastener to define a general point of attachment. The insulating member is configured to accept a fastener that can be utilized to mount the motor casing to the fan housing at the general point of attachment such that the fastener would be insulated from the motor casing.

According to yet another aspect, an insulated mounting arrangement for mounting an electric motor to a fan housing of an electric fan is generally provided. In one embodiment, the arrangement includes a mounting portion of a motor casing of the motor having a mounting aperture therein, an insulating member having at least a portion disposed within the mounting aperture of the motor casing, and a screw disposed through a portion of the fan housing and within the insulating member such that the screw is insulated from the motor casing.

According to another aspect, the insulating member includes a base portion and a protrusion extending therefrom, the protrusion being mounted to the mounting portion of the motor casing. In a particular embodiment, the protrusion in press-fit into a mounting aperture within the mounting portion of the motor casing.

According to yet another aspect, an insulated mounting arrangement for mounting an electric motor to a fan housing of an electric fan is provided where the arrangement includes a mounting portion of a motor casing of the motor, an insulating member connected to the mounting portion of the motor casing, and a motor mount portion of the fan housing. The insulating member is configured to directly engage the motor mount portion of the fan housing without separate fasteners. The engagement electrically insulates the fan housing from the motor casing.

According to yet another aspect, an electric fan is provided comprising a fan housing having a peripheral shroud portion and a front and a rear grill portion each disposed adjacent the shroud portion. The shroud portion and the grill portions define an interior region of the fan housing within which a motorized blade assembly is mounted to a motor mount portion of the fan housing such that the motorized blade assembly is electrically insulated from the fan housing. The motorized blade assembly includes a motor having a motor casing. The motor casing includes a vented rear surface disposed adjacent to the rear grill portion. The rear grill portion includes a first mesh portion and a second mesh portion defined by a plurality of openings within the rear grill portion. The second mesh portion is disposed adjacent to the vented rear surface of the motor casing. The openings of the second mesh portion are dimensioned such that a user's finger cannot pass therethrough and contact the motor casing while allowing sufficient air flow to cool the motor.

According to another aspect, an electric fan having at least one control is provided. The fan comprises a fan housing and a control casing attached to the fan housing and configured to house the at least one control of the fan. The casing is configured to electrically isolate the at least one control from the fan housing.

According to yet another aspect, an insulated mounting arrangement for mounting an electric motor to a fan housing of an electric fan is provided. The arrangement comprises a mounting portion of a motor casing of the electric motor, an insulating member mounted to the fan housing, and a fastener disposed through the insulating member and within the mounting portion of the motor casing such that the fan housing is insulated from the motor casing and the fastener.

These and other aspects will become apparent from a review of the Drawings, Detailed Description and the claims.

### BRIEF DESCRIPTION OF THE DRAWINGS

FIG. 1 is a perspective view of a fan assembly having a portion of a rear fan grill cut away to show an insulator mounting arrangement of an electric motor of the fan assembly in accordance with the principles of the present invention.

FIG. 2 is a perspective view of a motor showing a plurality of insulating members mounted thereto, one of the insulating members being shown in exploded view.

FIG. 3 is an elevational view of the motor of FIG. 2 mounted to a portion of a fan housing with screws, two of the mounting areas being shown in cross-section.

FIG. 4 is a detailed view of one of the mounting areas shown in FIG. 3.

FIG. 5 is a partial cross-sectional view of a mounting area having an alternative mounting arrangement utilizing an alternative embodiment of an insulating member.

FIG. 6 is an assembly view of a motor mount portion of a fan housing and the alternative insulating member shown in FIG. 5, the motor mount portion including a slot that is configured to cooperate with the insulating member to mount the motor to the fan housing.

FIG. 7 is a partial cross-sectional view of a mounting area having an alternative mounting arrangement utilizing an alternative embodiment of an insulating member.

FIG. 8 is a plan view of a rear fan grill of the fan assembly shown in FIG. 1.

FIG. 9 is a perspective view of a control module for a fan in accordance with the principles of the present invention.

FIG. 10 is a partial elevational view of the control module of FIG. 8 shown mounted to a fan housing.

FIG. 11 is a partial perspective view of the control module shown in FIG. 9, with one case portion of a case of the module being unattached to another case portion of the case.

### DETAILED DESCRIPTION OF THE PREFERRED EMBODIMENTS

While the present invention will be described fully hereinafter with reference to the accompanying drawings, in which one or more particular embodiments is shown, it is to be understood at the outset that persons skilled in the art may modify the embodiments herein described while still achieving the desired result of this invention. Accordingly, the description which follows is to be understood as an informative disclosure of one or more specific embodiments in accordance with the general principles of the invention directed to the understanding by persons skilled in the appropriate arts of those principles, and not as limitations of the present invention.

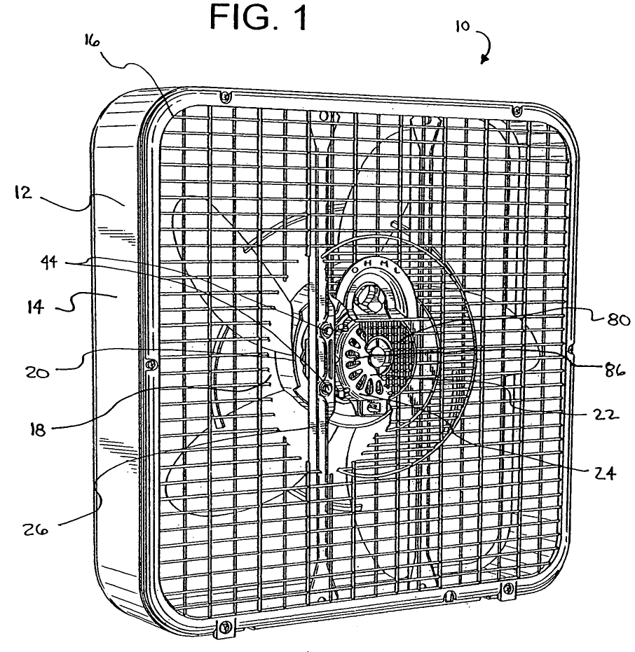

Referring to FIG. 1, an embodiment incorporating the principles of the present invention is shown as an electric fan assembly 10. The fan assembly 10 includes a fan housing 12 having a peripheral shroud portion 14 and two grill portions, a rear grill portion 16 and a front grill portion (not shown). In a particular embodiment suited for application of the principles of the present invention, the fan housing 12 is made of a metallic material and the grill portions are made of a molded plastic material. Each of the grill portions are disposed adjacent the shroud portion 14. The shroud portion 14 together with the grill portions define an interior region 18 of the fan housing 12 within which a motorized blade assembly 20 is disposed.

The motorized blade assembly 20 includes a motor 22 having a motor casing 24. In a preferred embodiment, the motor casing 24 is made of a cast metal. As shown in the cut away portion of FIG. 1, the motor 22 is mounted to a motor mount portion of the fan housing 12. In a preferred embodiment, the motor 22 is mounted to a pair of mounting brackets 26 as shown in FIG. 1.

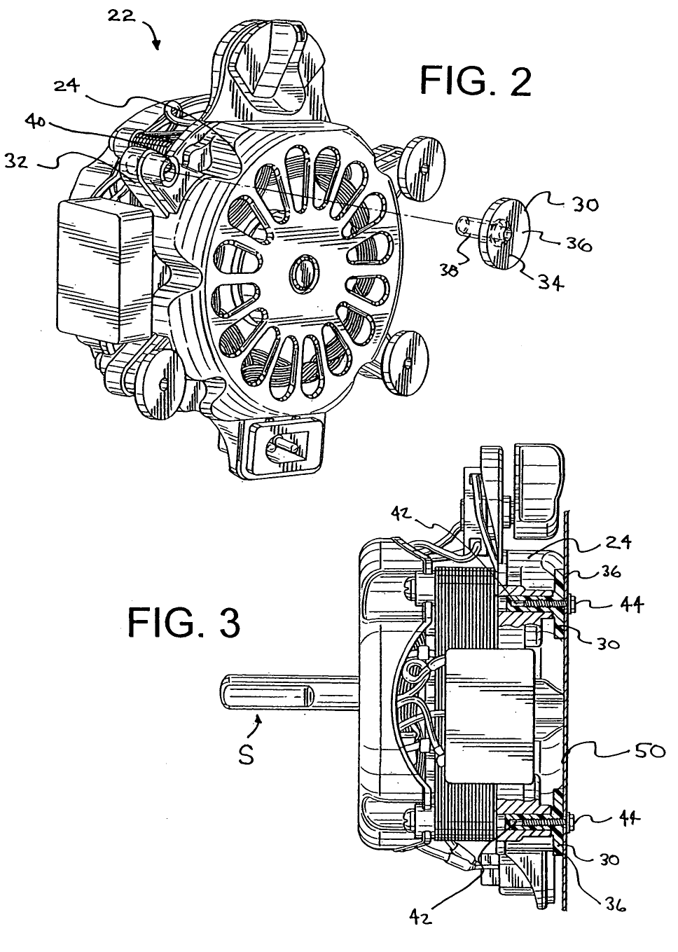

In accordance with the principles of the present invention, the motor 22 is mounted to the fan housing 12 in an insulated mounting arrangement. Referring to FIGS. 2-4, the arrangement includes at least one insulating member 30 connected to a mounting portion 32 of the motor casing 24. Although the mounting portion 32 is shown in this embodiment as a portion outwardly and radially extending from the motor casing 32, the mounting portion can be in any form, and integrated with, or separately attached to, the motor casing 24, as long as the mounting portion 32 facilitates attachment of the insulating member 30, either directly or indirectly, to the motor casing 24. In a preferred embodiment, there are four insulating members 30 disposed about the motor casing 24 of the motor 22.

The insulating member 30 preferably includes a base portion 34 having a mounting surface 36 and a protrusion 38 extending therefrom. The protrusion 38 of the insulating member 30 is configured to be securely disposed within a mounting aperture 40 of the motor casing 24, thereby defining a general point of attachment to the motor casing 24. Preferably, the protrusion 38 has an interference fit with the mounting aperture 40 and is pressed therein by suitable manufacturing methods. However, the protrusion 38 can be securely disposed within the mounting aperture by any number of means, including by means of adhesive, insertion during casting or molding, snap fitting or other mechanical fastening arrangement, weldment, etc. According to a particular aspect of the invention, it is preferable that the mounting be facilitated without the use of a separate fastener.

As an alternate embodiment, an insulator member can be completely integrated within the motor casing, such as by insertion during casting, wherein the whole insulator member—in lieu of a protrusion, such as the protrusion 38—could define a general point of attachment. In yet another embodiment, a protrusion of the insulator member can be mounted in a radial direction with respect to the motor casing (i.e., generally transverse to an axis defined by a motor shaft S), in lieu of an axial direction as shown in FIGS. 2 and 3. In such an embodiment, the general point of attachment would be generally transverse to a direction of the mounting of the motor casing to the fan housing (i.e., the axial direction). In such a case, the mounting of the motor casing to the fan housing is still considered as being at the general point of attachment, since the mounting is generally positioned within, or adjacent to, a plane in the radial direction extending through the point of attachment and the axis of the motor shaft S.

If desired, the motor 22 can be supplied as a unit that includes the insulating members 30 secured thereto and ready for assembly to the fan housing 12.

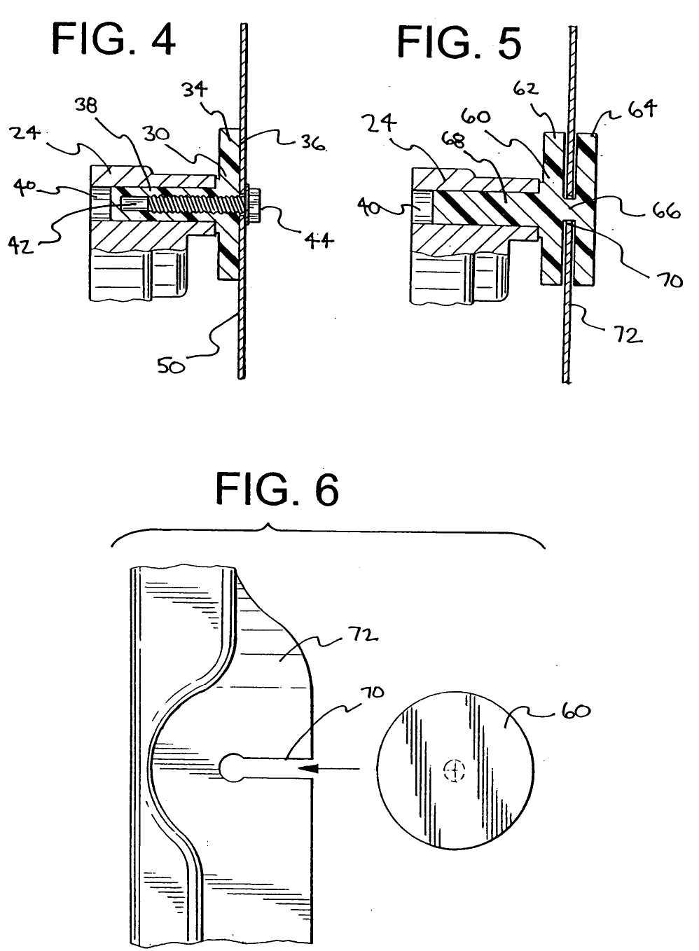

According to a particular aspect of the invention, the general point of attachment can serve as a mounting area for mounting the motor casing to the fan housing. This is particularly facilitated in embodiments where the insulator member is mounted to the motor casing without the use of separate fasteners at the general point of attachment, which could otherwise interfere with the mounting of the motor casing to the fan housing. In the embodiment shown in FIGS. 1-4, the protrusion 38 of the insulating member 30 includes a blind hole 42 configured to accept a screw or fastener 44 (best shown in FIGS. 3 and 4). Preferably, the fastener is a self-tapping or thread-forming screw. As shown in FIGS. 3 and 4, the mounting surface 36 of the base portion 34 of the insulating member 30 is arranged to oppose a mounting surface 50 of the fan housing 12 when the motor 22 is mounted to the fan housing 12 by the fastener 44. The fastener 44 passes through the mounting surface 50 of the fan housing 12 and penetrates the base portion 34 and the protrusion 38 of the insulating member 30. As best shown in FIG. 4, the fastener 44 is insulated from the motor casing 24 when the motor is mounted to the fan housing 12. The insulating member 30 acts as an electrically insulating barrier between the fastener 44 and the motor casing 24 as well as between the motor casing 24 and the fan housing 12. Thus, in the case of a current leakage from the motor 22 that charges the motor casing 24, the current cannot establish a path to the fan housing 12. The mounting surface 36 of the base portion 34 is preferably designed to be large enough to prevent moisture from completely tracking across the mounting surface 36 and grounding the motor casing 24 to the fan housing 12.

According to another aspect of the invention, the insulating member 30 can be configured to directly engage the motor mount portion of the fan housing 12 without separate fasteners. In this type of arrangement, the insulating member 30 itself would act as both a fastener and an insulator between the motor casing 24 and the fan housing 12. This arrangement can be achieved through the use of a snap fit with a portion of the fan housing 12, a key fit within an aperture arrangement in the fan housing 12, or other suitable arrangement that does not require the use of a separate fastener. In one particular embodiment as shown in FIGS. 5 and 6, an insulating member 60 is provided, which includes a first base member 62 and a second base member 64 having a neck portion 66 disposed therebetween. The insulating member 60 also includes a protrusion 68 that engages the mounting aperture 40 of the motor casing 24. The neck portion 66 is configured to engage a slot 70 within a motor mount portion 72 of a fan housing and the base members 64 and 66 of the insulating member 60 cooperate to engage the motor mount portion 72. Numerous other embodiments are contemplated having the common feature of avoiding the use of separate fasteners for mounting the motor to the fan housing.

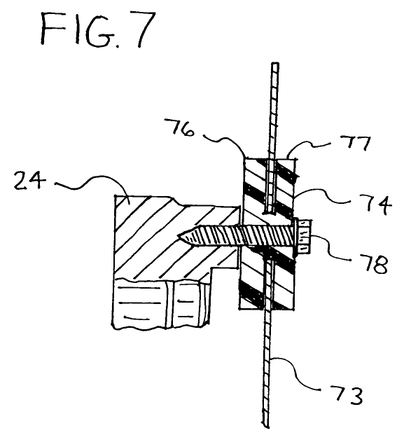

According to another aspect of the invention, insulation between the motor casing 24 and a portion of a fan housing 73 is facilitated by incorporating one or more insulating members 74 that are mounted within an aperture 75 of the portion of the fan housing 73 as shown in FIG. 7. In this embodiment, the insulating member 74 has a first portion 76—defining an insulating portion between the motor casing and the portion of the fan housing—and a second portion 77—defining an insulating portion between the portion of the fan housing 73 and a fastener 78. In such an embodiment, the fastener 78 can be allowed to penetrate the motor casing 24 while still being isolated from the fan housing 73. In a preferred embodiment according to this aspect of the invention, the insulating member 74 is a grommet or grommet-like element made of a resilient insulating material.

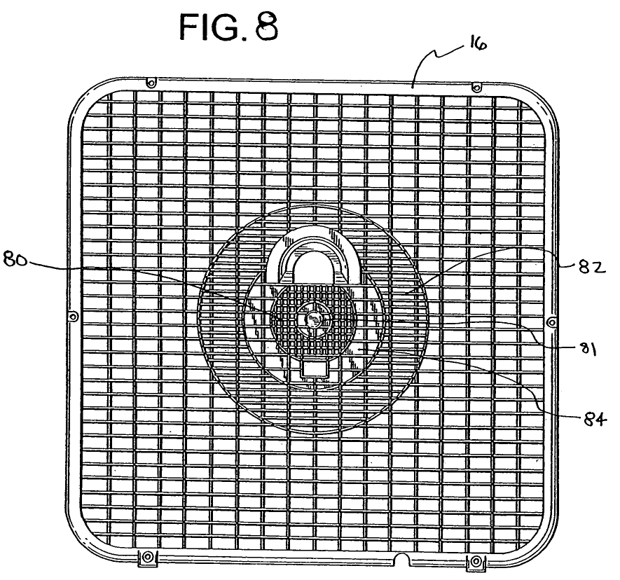

According to yet another aspect of the present invention, the rear grill portion 16 includes a first mesh portion 80 concentrically disposed about a centrally disposed first solid surface portion 81 and a second mesh portion 82 concentrically disposed about the first mesh portion 80, as shown in FIG. 8. A second solid surface portion 84 is disposed therebetween. The mesh portions 80 and 82 are defined by a plurality of openings within the rear grill portion 16, as best shown in FIG. 8. The first mesh portion 80 is configured to be disposed adjacent to a vented rear surface 86 of the motor casing 24 in the fan assembly, as shown in FIG. 1. The openings of the first mesh portion 80 are dimensioned such that a user's finger cannot pass therethrough and contact the motor casing 24 while still allowing sufficient air flow to cool the motor 22. The solid surface portion 84 provides an additional barrier between the mounting area and the user. The second mesh portion 82 also provides an additional barrier while still allowing air to flow therethrough. These features, alone and in combination, contribute to an insulating barrier between the motor 22 and the user.

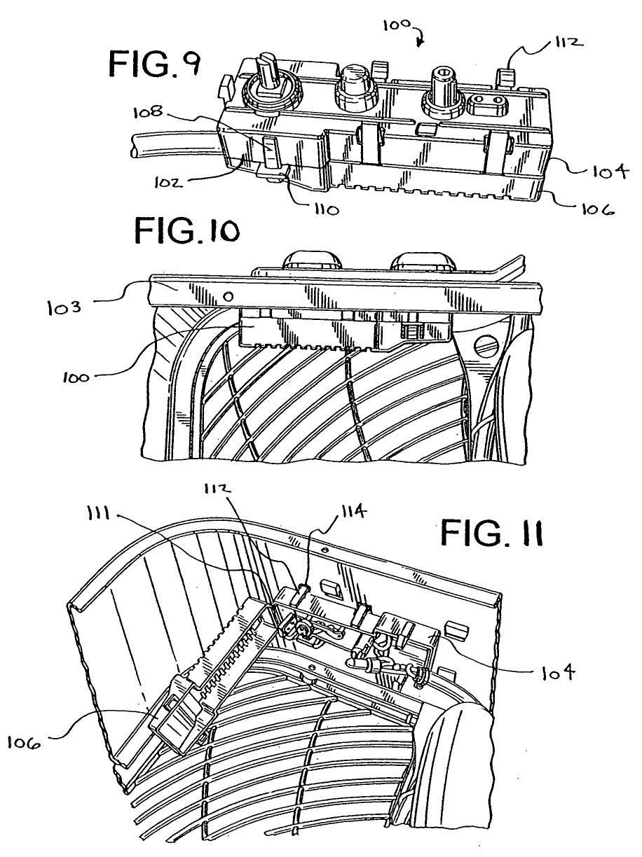

In fan embodiments that do not incorporate motor assemblies having controls that are integrated into the motor casing or disposed adjacent thereto—such as, for example, the motor 22 as depicted in FIGS. 1-3, wherein the controls are isolated via the insulator members—it may be desirable to separately isolate the controls and associated electrical peripherals. Referring to FIGS. 9-11, a control module 100 having a casing 102 is depicted, wherein one or more controls and associated electrical peripherals (such as a plug receptacle, a light or LED indicator, a fuse holder, associated wiring and/or wiring connections, terminals, etc.) of the fan are isolated from surrounding components that may conduct electrical current to a user, such as a fan housing 103. In the embodiment shown, the control casing 102 includes a first casing portion 104 and a second casing portion 106. The casing portions may include attachment features in the form of one or more snap protrusions 108 and corresponding latch features 110, as shown in FIGS. 9-11, which facilitate attachment of the casing portions 104 and 106 to each other. In this particular embodiment, the casing portions 104 and 106 include a hinge 111 (shown in FIG. 11) that hingedly connects the casing portions 104 and 106 together. Preferably, the hinge is formed from a web of material that is contiguous with the casing portions 104 and 106. However, the casing portions 104 and 106 could also be completely separable. Although this is a preferable attachment arrangement, which could allow disassembly of the casing portions if desired, the casing portions could also be permanently attached to each other, such as by adhesive, weldment (such as sonic weldment), or other means. In such an embodiment, the control module 100 could be treated as a single drop-in replaceable module.

One or both of the casing portions 104 and 106 may also include an attachment feature to facilitate attachment to the fan housing 103, such as one or more snap protrusions 112, which engage the fan housing 103 via one or more corresponding snap apertures 114 within the fan housing 103. When assembled in a fan assembly, the casing 102 provides isolation of electrical componentry, which alone or in combination with other aspects of the invention described herein, contributes to providing an insulating barrier between electrical elements of the fan assembly and the user.

While one or more specific embodiments have been illustrated and described, numerous modifications may come to mind without significantly departing from the spirit of the invention, and the scope of protection is only limited by the scope of the accompanying claims.

1. An electric motor for an electric fan having a fan housing, the motor comprising a motor casing having an insulator mounting arrangement configured for mounting the motor to the fan housing, the mounting arrangement comprising:
a mounting portion of the motor casing; and
an insulating member mounted to the mounting portion of the motor casing without a separate fastener;
the insulating member configured to accept a fastener that can be utilized to mount the motor casing to the fan housing such that the motor casing and the fan housing are insulated from each other.

2. The electric motor of claim 1, wherein the insulating member includes a base portion and a protrusion extending therefrom, the protrusion being mounted to the mounting portion of the motor casing.

3. The electric motor of claim 1, wherein at least a portion of the insulating member is disposed within a mounting aperture disposed within the mounting portion of the motor casing.

4. The electric motor of claim 2, wherein the base portion of the insulating member is disk shaped.

5. The electric motor of claim 2, wherein the protrusion includes a hole therein to accept the fastener.

6. The electric motor of claim 3, wherein the portion of the insulating member is securely fit within the mounting aperture of the motor casing.

7. The electric motor of claim 3, wherein the portion of the insulating member is press-fit within the mounting aperture of the motor casing.

8. The electric motor of claim 1, wherein a general point of attachment is defined by the mounting of the insulator member to the motor casing.

9. The electric motor of claim 8, wherein the insulating member accepts the fastener at the general point of attachment.

10. The electric motor of claim 1, further comprising:
a second mounting portion of the motor casing; and
a second insulating member mounted to the second mounting portion of the motor casing without a separate fastener;
the second insulating member configured to accept a second fastener that can be utilized to mount the motor casing to the fan housing such that the motor casing and the fan housing are insulated from each other.

11. The electric motor of claim 1, wherein the insulating member is further configured to insulate the fastener from the motor casing when the motor casing is mounted to the fan housing.

12. An insulated mounting arrangement for mounting an electric motor to a fan housing of an electric fan, the arrangement comprising:
a mounting portion of a motor casing of the electric motor;
an insulating member mounted to the mounting portion of the motor casing without a separate fastener; and
a fastener disposed through a portion of the fan housing and within the insulating member such that the fan housing is insulated from the motor casing.

13. The arrangement of claim 12, wherein the insulating member includes a base portion and a protrusion extending therefrom, the protrusion being mounted to the mounting portion of the motor casing.

14. The arrangement of claim 13, wherein the protrusion includes a hole therein to accept the fastener.

15. The arrangement of claim 12, wherein at least a portion of the insulating member is disposed within a mounting aperture disposed within the mounting portion of the motor casing.

16. The arrangement of claim 15, wherein the portion of the insulating member is securely fit within the mounting aperture of the motor casing.

17. The arrangement of claim 15, wherein the portion of the insulating member is press-fit within the mounting aperture of the motor casing.

18. The arrangement of claim 12, wherein a general point of attachment is defined by the mounting of the insulator member to the motor casing.

19. The arrangement of claim 18, wherein the insulating member accepts the fastener at the general point of attachment.

20. The arrangement of claim 12, further comprising:
a second mounting portion of the motor casing of the electric motor;
a second insulating member mounted to the second mounting portion of the motor casing without a separate fastener; and
a second fastener disposed through a second portion of the fan housing and within the second insulating member such that the second fastener is insulated from the motor casing.

21. The arrangement of claim 12, wherein the insulating member insulates the fastener from the motor casing.

22. An electric motor for an electric fan having a fan housing, the motor comprising a motor casing having an insulator mounting arrangement configured for mounting the motor to the fan housing, the mounting arrangement comprising:
a mounting portion of the motor casing; and
an insulating member mounted to the mounting portion of the motor casing without a separate fastener to define a general point of attachment;
the insulating member configured to accept a fastener that can be utilized to mount the motor casing to the fan housing at the general point of attachment such that the motor casing would be insulated from the fan housing.

23. The electric motor of claim 22, wherein at least a portion of the insulating member is mounted within an aperture within the mounting portion of the motor casing.

24. The electric motor of claim 23, wherein the portion of the insulating member is press-fit into the aperture.

25. An insulated mounting arrangement for mounting an electric motor to a fan housing of an electric fan, the arrangement comprising:
a mounting portion of a motor casing of the electric motor;
an insulating member mounted to the mounting portion of the motor casing without a separate fastener to define a general point of attachment; and
a fastener disposed through a portion of the fan housing and within the insulating member at the point of attachment such that the fan housing is insulated from the motor casing.

26. The arrangement of claim 25, wherein the fastener is insulated from the motor casing by the insulating member.

27. The arrangement of claim 25, wherein at least a portion of the insulating member is mounted within an aperture within the mounting portion of the motor casing.

28. The arrangement of claim 26, wherein the portion of the insulating member is press-fit into the aperture.

29. An electric motor for an electric fan having a fan housing, the motor comprising a motor casing having an insulator mounting arrangement configured for mounting the motor to the fan housing, the mounting arrangement comprising:
a mounting portion of the motor casing having a mounting aperture therein; and
an insulating member having at least a portion disposed within the mounting aperture to define a general point of attachment to the motor casing;
the insulating member configured to accept a fastener disposed through a portion of the fan housing at the point of attachment such that the fan housing and the fastener would be insulated from the motor casing.

30. An insulated mounting arrangement for mounting an electric motor to a fan housing of an electric fan, the arrangement comprising:
a mounting portion of a motor casing of the motor having a mounting aperture therein;
an insulating member having at least a portion disposed within the mounting aperture of the motor casing; and
a fastener disposed through a portion of the fan housing and within the insulating member such that the fan housing and the fastener are insulated from the motor casing.

31. The mounting arrangement of claim 30, wherein the insulating member includes a base portion and a protrusion extending therefrom, the protrusion being disposed within the mounting aperture of the motor casing.

32. The mounting arrangement of claim 31, wherein the base portion of the insulating member is disk shaped.

33. The mounting arrangement of claim 31, wherein the protrusion includes a hole therein to accept the fastener.

34. The mounting arrangement of claim 30, wherein the portion of the insulating member is securely fit within the mounting aperture of the motor casing.

35. The mounting arrangement of claim 30, wherein the portion of the insulating member is press-fit within the mounting aperture of the motor casing.

36. The mounting arrangement of claim 30, further comprising:
a second mounting portion of the motor casing of the motor having a mounting aperture therein;
a second insulating member having at least a portion disposed within the mounting aperture of the second mounting portion of the motor casing; and
a second fastener disposed through a second portion of the fan housing and within the second insulating member such that the fastener is insulated from the motor casing.

37. An electric motor for an electric fan having a fan housing, the motor comprising a motor casing having an insulator mounting arrangement configured for mounting the motor to the fan housing, the mounting arrangement comprising four insulating members each mounted to the motor casing without a separate fastener to define four general points of attachment, each of the insulating members configured to accept a fastener that can be utilized to mount the motor casing to the fan housing at the general points of attachment such that the fan housing would be insulated from the motor casing.

38. An insulator member configured for use in mounting an electric motor to a housing of an electric fan assembly, the motor including a motor casing having at least one mounting aperture, the insulator member comprising:
a base portion having a mounting surface; and
a protrusion extending from the base portion, the protrusion configured to be securely disposed within the mounting aperture of the motor casing;
wherein the mounting surface of the base portion is arranged to oppose a mounting surface of the housing when the motor is mounted to the housing by a fastener that passes through the mounting surface of the housing and penetrates the base portion and the protrusion, the fastener being insulated from the motor casing when the motor is mounted.

39. The insulator member of claim 38, wherein the protrusion is configured to be press-fit into the mounting aperture of the motor casing.

40. The insulator member of claim 38, wherein the protrusion includes a hole therein to accept the fastener.

41. The insulator member of claim 40, wherein the hole is configured to accept a thread-forming fastener.

42. The insulator member of claim 38, wherein the base portion having the mounting surface has a disk shape.

43. An insulated mounting arrangement for mounting an electric motor to a fan housing of an electric fan, the arrangement comprising:
a mounting portion of a motor casing of the motor having a mounting aperture therein;
an insulating member having a base portion and a protrusion extending therefrom, the protrusion disposed within the mounting aperture of the motor casing; and
a fastener disposed through a portion of the fan housing and within the protrusion such that the fan housing and the fastener are insulated from the motor casing.

44. The mounting arrangement of claim 43, further comprising:
a second mounting portion of the motor casing of the motor having a mounting aperture therein;
a second insulating member having a base portion and a protrusion extending therefrom, the protrusion disposed within the mounting aperture of the second mounting portion of the motor casing; and
a second fastener disposed through a second portion of the fan housing and within the protrusion of the second insulating member such that the fan housing and the second fastener are insulated from the motor casing.

45. An electric motor for an electric fan having a fan housing, the motor comprising a motor casing having an insulator mounting arrangement configured for mounting the motor to the fan housing, the mounting arrangement comprising four insulating members each mounted to the motor casing, each of the insulating members configured to accept a fastener that can be utilized to mount the motor casing to the fan housing such that the fan housing would be insulated from the motor casing.

46. The motor of claim 45, wherein the insulating members are further configured such that the fastener would be insulated from the motor casing when the motor casing is mounted to the fan housing.

53. An insulated mounting arrangement for mounting an electric motor to a fan housing of an electric fan, the arrangement comprising:
a mounting portion of a motor casing of the motor;
an insulating member connected to the mounting portion of the motor casing; and
a motor mount portion of the fan housing;
the insulating member configured to directly engage the motor mount portion of the fan housing without a separate fastener such that the engagement electrically insulates the fan housing from the motor casing.

54. An electric motor for an electric fan having a fan housing, the motor comprising a motor casing having an insulator mounting arrangement configured for mounting the motor to the fan housing, the mounting arrangement comprising:
a mounting portion of the motor casing having a mounting aperture therein; and
an insulating member having at least a portion disposed within the mounting aperture;
the insulating member configured to accept a fastener disposed through a portion of the fan housing such that the fastener is insulated from the motor casing.

55. The motor of claim 54, wherein the insulating member includes an aperture configured to accept the fastener.

56. The motor of claim 55, wherein the aperture of the insulating member is a hole that is substantially concentrically positioned with respect to the mounting aperture.

57. The motor of claim 54, wherein the insulating member includes a base portion and a protrusion extending therefrom, the protrusion being disposed within the mounting aperture of the motor casing.

58. The motor of claim 54, wherein the portion of the insulating member disposed within the mounting aperture is press-fit therein.

59. An electric motor for an electric fan having a fan housing, the motor comprising a motor casing having an insulator mounting arrangement configured for mounting the motor to the fan housing, the mounting arrangement comprising:
at least two mounting portions of the motor casing each having a mounting aperture therein; and
at least two insulating members each having at least a portion disposed within one of the mounting apertures;
each of the insulating members configured to accept a fastener disposed through a portion of the fan housing such that the fastener is insulated from the motor casing.

60. An electric fan comprising:
a fan housing; and
a motorized blade assembly disposed within the fan housing, the motorized blade assembly including an electric motor having a motor casing, the motor casing having a mounting portion having a mounting aperture therein and an insulating member having at least a portion disposed within the mounting aperture to define a general point of attachment to the motor casing, the insulating member having a fastener received therein at the general point of attachment such that the fastener is insulated from the motor casing, the fastener being disposed through a portion of the fan housing to facilitate attachment of the motor to the fan housing.

64. An insulated mounting arrangement for mounting an electric motor to a fan housing of an electric fan, the arrangement comprising:
a first and a second mounting portion of a motor casing of the motor;
a first insulating member mounted to the first mounting portion of the motor casing;
a second insulating member mounted to the second mounting portion of the motor casing;
a first fastener disposed through a first portion of the fan housing and the first insulating member; and
a second fastener disposed through a second portion of the fan housing and the second insulating member;
wherein the motor casing is insulated from the fan housing.

65. An electric motor for an electric fan having a fan housing, the motor comprising a motor casing having an insulator mounting arrangement configured for mounting the motor to the fan housing, the mounting arrangement comprising:
a first and a second mounting portion of a motor casing of the motor;
a first insulating member mounted to the first mounting portion of the motor casing;
a second insulating member mounted to the second mounting portion of the motor casing;
the first insulating member configured to accept a first fastener utilized when the motor casing is mounted to the fan housing; and
the second insulating member configured to accept a second fastener utilized when the motor casing is mounted to the fan housing;
wherein the motor casing is insulated from the fan housing when mounted thereto.

66. An insulated mounting arrangement for mounting an electric motor to a fan housing of an electric fan, the arrangement comprising:
a mounting portion of a motor casing of the electric motor;
an insulating member mounted to the fan housing; and
a fastener disposed through the insulating member and within the mounting portion of the motor casing such that the fan housing is insulated from the motor casing and the fastener.

67. The arrangement of claim 66, wherein the insulating member is mounted to the fan housing without a fastener.

68. The arrangement of claim 66, wherein the insulating member is mounted within an aperture within the fan housing.

69. The arrangement of claim 66, wherein the insulating member comprises a first portion disposed between the motor casing and the fan housing and a second portion disposed between the fan housing and the fastener.

70. The arrangement of claim 66, further comprising:
a second mounting portion of the motor casing of the electric motor;
a second insulating member mounted to the fan housing; and
a second fastener disposed through the second insulating member and within the second mounting portion of the motor casing such that the fan housing is insulated from the motor casing and the second fastener.

71. An electric fan having a fan housing and a motor, the motor comprising a motor casing having an insulator mounting arrangement configured for mounting the motor to the fan housing, the mounting arrangement comprising four insulating members each mounted to the fan housing, each of the insulating members configured to accept one of four fasteners that mount the motor casing to the fan housing such that the fan housing is insulated from the motor casing.

72. The electric fan of claim 71, wherein each of the fasteners are insulated from the fan housing.

73. The electric fan of claim 71, wherein the insulating member comprises a first portion disposed between the motor casing and the fan housing and a second portion disposed between the fan housing and the fastener.
